(19) United States
(12) Patent Application Publication
(10) Pub. No.: US 2026/0192659 A1
(43) Pub. Date: Jul. 9, 2026

(54) SYSTEM AND METHOD FOR PROTECTING DIFFERENTIAL ASSEMBLY IN AN ELECTRIFIED VEHICLE

(71) Applicant: FCA US LLC, Auburn Hills, MI (US)

(72) Inventors: Shichao Huo, Auburn Hills, MI (US); Xin Diao, Auburn Hills, MI (US); Justin Padinjaremury, Auburn Hills, MI (US); Ashay Sharma, Auburn Hills, MI (US)

(21) Appl. No.: 19/013,185

(22) Filed: Jan. 8, 2025

(51) Int. Cl. B60K 23/04

(52) U.S. Cl. CPC B60K 23/04; B60K 2023/043

(57) ABSTRACT

A vehicle system for an electrified vehicle limits torque delivery to drive wheels of the electrified vehicle and includes an electric motor, wheel speed sensors and a controller. The controller: receives first and second wheel speed signals; determines, based on a difference between the first and second wheel speed signals, a differential protection torque limit; determines whether the propulsion torque exceeds a differential protection torque limit; determines a slip stress power; determines a slip stress energy based on the slip stress power; determines whether the slip stress energy is greater than a dwell energy threshold; determines whether the slip stress energy is greater than or equal to a maximum slip stress energy; and commands, at the electric motor, the propulsion torque to the differential protection limit based on the slip stress energy being greater than or equal to the maximum slip stress energy.

### FIELD

The present disclosure relates generally to a system and method for limiting torque delivery from an electric motor to a differential assembly based on wheel slip.

### BACKGROUND

An electrified vehicle (hybrid electric, plug-in hybrid electric, range-extended electric, battery electric, etc.) includes at least one battery system and at least one electric motor. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) converter.

When driving an electrified vehicle on a slippery surface, a driven wheel can have different speed between a left drive wheel and a right drive wheel. These speed differences can lead to failures in one or more gears in a differential assembly. The issue is especially pronounced in electrified vehicles due to the fact that electric motors have lower inertia and a higher torque response which increases the likelihood of massive wheel slip and wheel speed difference. Furthermore, noise and vibration feedback of the powertrain is lower in electrified vehicles. As a result, a driver is generally less likely to reduce an acceleration input when wheel slip occurs. Previous attempts to address this concern include relying on an electronic stability control system or implementing limited slip differentials. However, these prior art configurations do not suitably protect the differential assembly from all electric motor torque inputs. As such, there remains a need for improvement in the relevant art.

### SUMMARY

In one example aspect of the invention, a vehicle system for an electrified vehicle limits torque delivery to drive wheels of the electrified vehicle and includes an electric motor, wheel speed sensors and a controller. The electric motor provides propulsion torque to a driveline that drives the drive wheels for propelling the vehicle, the drive wheels including left and right drive wheels receiving the propulsion torque through a differential assembly. The wheel speed sensors include a first wheel speed sensor that communicates a first wheel speed signal of the left drive wheel and a second wheel speed sensor that communicates a second wheel speed signal of the right drive wheel. The controller: receives the first and second wheel speed signals; determines, based on a difference between the first and second wheel speed signals, a differential protection torque limit; determines whether the propulsion torque exceeds a differential protection torque limit; determines a slip stress power; determines a slip stress energy based on the slip stress power; determines whether the slip stress energy is greater than a dwell energy threshold; determines whether the slip stress energy is greater than or equal to a maximum slip stress energy; and commands, at the electric motor, the propulsion torque to the differential protection limit based on the slip stress energy being greater than or equal to the maximum slip stress energy.

In another aspect, the controller is further configured to command, at the electric motor, a blending in from a driver commanded propulsion torque to the differential protection limit.

In some implementations, the controller is further configured to command, at the electric motor, the blending until the slip stress energy is equal to the maximum slip stress energy.

In some configurations, the controller is further configured to determine the slip stress power including calculating a positive slip stress power as a function of the propulsion torque and the slip speed.

According to additional examples, the controller is further configured to determine the slip stress power including calculating a negative dissipative slip stress power as a function of the slip stress energy.

In additional implementations, the left and right drive wheels comprise left and right front drive wheels.

In examples, the left and right drive wheels comprise left and right rear drive wheels.

In other examples, the left and right drive wheels comprise: left and right front drive wheels; and left and right rear drive wheels.

A method for limiting torque delivery to drive wheels of the electrified vehicle is provided. The electrified vehicle has: an electric motor that provides propulsion torque to a driveline that drives the drive wheels for propelling the vehicle, the drive wheels including left and right drive wheels receiving the propulsion torque through a differential assembly; a first wheel speed sensor that communicates a first wheel speed signal of the left drive wheel and a second wheel speed sensor that communicates a second wheel speed signal of the right drive wheel; and a controller. The method includes: receiving, at the controller, the first and second wheel speed signals; determining, at the controller, based on a difference between the first and second wheel speed signals, a differential protection torque limit; determining, at the controller, whether the propulsion torque exceeds a differential protection torque limit; determining, at the controller, a slip stress power; determining, at the controller, a slip stress energy based on the slip stress power; determining, at the controller, whether the slip stress energy is greater than a dwell energy threshold; determining, at the controller, whether the slip stress energy is greater than or equal to a maximum slip stress energy; and commanding, at the electric motor, the propulsion torque to the differential protection limit based on the slip stress energy being greater than or equal to the maximum slip stress energy.

In another aspect, the method includes: commanding, at the electric motor, a blending in from a driver commanded propulsion torque to the differential protection limit.

In another aspect, the method includes: commanding, at the electric motor, the blending until the slip stress energy is equal to the maximum slip stress energy.

In another aspect, the method includes: determining, at the controller, the slip stress power including calculating a positive slip stress power as a function of the propulsion torque and the slip speed.

In another aspect, the method includes: determining, at the controller, the slip stress power including calculating a negative dissipative slip stress power as a function of the slip stress energy.

In another aspect of the method, the left and right drive wheels comprise left and right front drive wheels.

In another aspect of the method, the left and right drive wheels comprise left and right rear drive wheels.

In another aspect of the method, the left and right drive wheels comprise left and right front drive wheels; and left and right rear drive wheels.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is a schematic block diagram of an exemplary vehicle system according to the principles of the present disclosure;

FIG. 2 is an exemplary logic flow diagram illustrating a method for implementing a control strategy for limiting torque delivery from an electric motor to a differential based on wheel slip;

FIGS. 3A and 3B is an example functional block diagram of a method implemented by an exemplary controller of the vehicle system of FIG. 1 according to the principles of the present disclosure; and

FIG. 4 are various plots illustrating a slip energy based activation of limits.

### DESCRIPTION

As identified above, when driving an electrified vehicle on a slippery surface, a driven wheel can have different speed between a left drive wheel and a right drive wheel. These speed differences can lead to failures in one or more gears (such as, the input ring gear, side gears, etc.) in a differential assembly (hereinafter “differential”). The issue is especially pronounced in electrified vehicles due to the fact that electric motors have lower inertia and a higher torque response which increases the likelihood of massive wheel slip and wheel speed difference. As used herein “wheel slip” refers to a condition where drive wheels experience a difference in expected speed. Furthermore, noise and vibration feedback of the powertrain is lower in electrified vehicles. As a result, a driver is generally less likely to reduce an acceleration input when wheel slip occurs. Previous attempts to address this concern include relying on an electronic stability control (ESC) system or implementing limited slip differentials. An ESC system does not suitable account for all use cases. In some extreme situations, such as off-roading, the ESC system does not protect the differential. If uncontrolled torque inputs happen repeatedly, the differential can fail much easier without the ESC system properly protecting it. Moreover, in many cases the ESC system can be turned off by the driver further exacerbating the problem of an unprotected differential. With regard to limited slip differentials, they involve more hardware and are additional cost. In addition, limited slip differentials are heavy and require more space.

The present disclosure provides a system and method for limiting torque delivery from an electric motor to a differential based on wheel slip. The system and method identifies and calculates the speed difference between the left and right wheel. An absolute calculation is made to confirm the result is always positive. In this regard, the system and method protects the differential even when the vehicle is travelling in reverse. The system and method of the instant application mitigates the speed difference of left and right drive wheels in an open differential. As a result, differential gear seizure is avoided. The system and method also maintains the vehicle performance at the same time and does not over-reduce the driver torque request. Therefore, the vehicle off-road capability is not compromised. The system and method is fully applicable for the front axle and rear axle, regardless if the vehicle is configured for, or operating in, a front wheel drive mode or all-wheel drive mode. In this regard, the system and method is suitable for electrified vehicles that are configured with a front wheel drive powertrain, a rear wheel drive powertrain, an all-wheel drive powertrain or a four wheel drive powertrain.

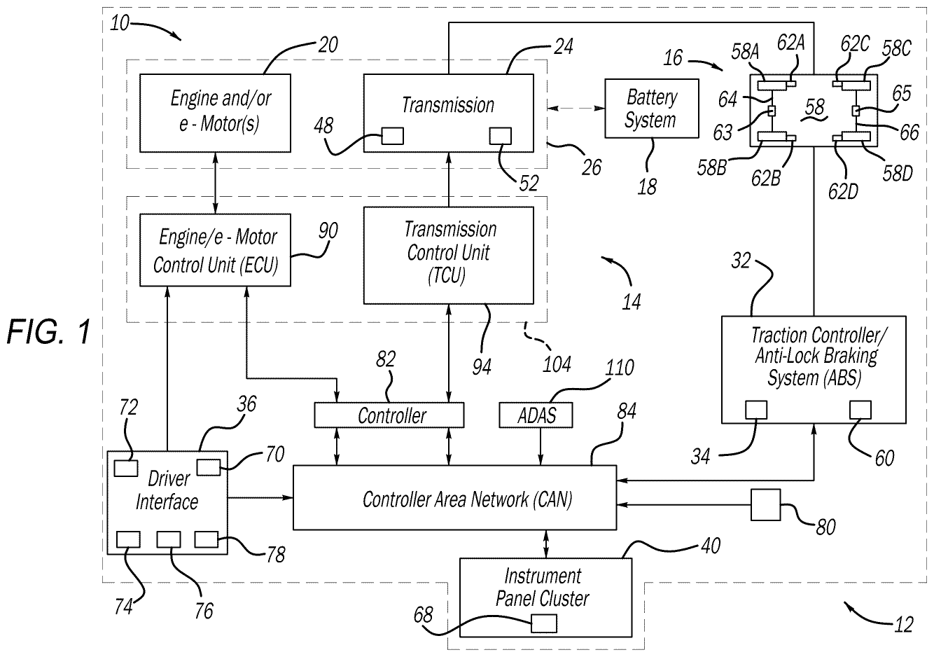

With initial reference to FIG. 1, an exemplary vehicle system is schematically shown and generally identified at reference numeral 10. The exemplary vehicle system 10 is associated with an exemplary vehicle 12 and includes a powertrain 14 configured to transfer drive torque to a driveline 16 of the vehicle 12 for propulsion. The powertrain 14 generally comprises a high voltage battery system 18, a motor 20 including at least one of an internal combustion engine (ICE) and one or more electric motors, and a transmission 24. The motor 20 and the transmission 24 can be collectively referred to herein as a drive module 26. While the exemplary implementation includes a transmission 24, in some examples the powertrain 14 does not include a transmission.

The vehicle system 10 further includes a traction controller and/or an anti-lock brake system (ABS) 32. While shown together, it will be appreciated that the vehicle system 10 can have a dedicated traction control system that operates independent of an anti-lock brake system. A yaw sensor 34 can be provided on the vehicle system 10 such as part of the traction controller ABS 32. The yaw sensor 34 is configured to sense a yaw condition of the vehicle 12. The vehicle system 10 further includes a driver interface 36 and an instrument panel or cluster 40. The instrument panel or cluster 40 can include any interface device, such as a driver information center, and/or vehicle infotainment system capable of receiving input from a driver.

As identified above, the motor 20 includes at least one of an internal combustion engine (ICE) and one or more electric motors. As such, the vehicle 12 can be powered exclusively by an ICE, exclusively by one or more electric motors, or can be powered by any combinations of and ICE and electric motors. The transmission 24 includes various transmission speed sensors, such as input and output transmission shaft speed sensors 48 and various shift sensors 52, to provide a signal to an associated control system indicative of a transmission gear selected. The transmission 24 and traction controller 32 are coupled or selectively coupled, directly or indirectly, to one or more wheels 58 of vehicle 12, as is known in the art. In the exemplary vehicle system, at least some of the wheels 58 are drive wheels that receive torque input from the motor 20.

The wheels 58 are identified individually as front wheels 58A, 58B and rear wheels 58C, 58D. The wheels 58A, 58B, 58C and 58D each have wheel speed sensors 62A, 62B, 62C and 62D. In the example shown, the front wheels 58A and 58B are selectively coupled through a front differential 63 by a front axle (e.g., front axle shafts) 64. Similarly, the rear wheels 58C and 58D are selectively coupled through a rear differential 65 by a rear axle (e.g., rear axle shafts) 66. Again, it is appreciated that in some implementations, the vehicle 12 can be configured as a front wheel drive vehicle where only the front wheels 58A and 58B are drive wheels. In such a configuration, the rear differential 65 may be excluded. Similarly, in other implementations, the vehicle 12 can be configured as a rear wheel drive vehicle where only the rear wheels 58C and 58D are drive wheels. In such a configuration, the front differential 63 may be excluded. In an all-wheel drive or four wheel drive configuration, both the front and rear differentials 63 and 65 can be incorporated for facilitating power flow from the motor 20 to all drive wheels 58. In the exemplary implementation illustrated, the traction controller 32 is controlled to activate foundation brakes 60.

The instrument panel cluster 40 includes various indicators, such as a wheel slip indicator 68 that can activate to convey to the driver a wheel slip condition. The driver interface 36 includes a steering wheel 70 and a brake pedal 72. The driver interface 36 includes a driver input device, e.g., an accelerator pedal 74, for providing a driver input, e.g., a torque request, for the motor 20. The driver interface 36 can further include a park brake 76. The driver interface 36 or vehicle interior also includes a transmission shift request device, such as a shift lever or rotary shifter 78, for the driver to request a desired gear of the transmission 24. The shift lever or rotary shifter 78 can provide conventional transmission options including park, reverse, neutral, drive and low.

One or more controllers 82 are utilized to control the various vehicle components or system discussed above. In one exemplary implementation, various individual controllers are utilized to control the various components/systems discussed herein and are in communication with each other and/or the various components/systems via a local interface 84. In this exemplary implementation, the local interface 84 is one or more buses or other wired or wireless connections, as is known in the art. In the example illustrated in FIG. 1, the local interface 84 is a controller area network (CAN). The CAN 84 may include additional elements or features, which have been omitted for simplicity, such as controllers, buffers (cache) drivers, repeaters and receivers, among many others, to enable communications. Further, the CAN 84 may include address, control and/or data connections to enable appropriate communications among the components/systems described herein.

The vehicle system 10 also includes sensors 80. The sensors 80 can provide inputs to the CAN 84 and therefore the controller 82 indicative of various operating conditions such as an oil temperature of the engine 20, a differential ring speed, a transmission temperature, a differential temperature, an ambient temperature, or other sensors that provides input indicative of, or related to, a wheel slip condition and/or a temperature of a component (differential) in the vehicle system 10.

The vehicle system 12 includes an advanced driver assistance system (ADAS) 110 that communicates signals to the controller 82 indicative of driving conditions. In examples, the ADAS 110 can include one or more cameras, radar/LIDAR sensors, and ultrasound sensors that detect obstacles and/or driving conditions. In examples, the controller 82 can communicate signals to the instrument panel cluster 40 to alert the driver of sensed conditions.

In the example illustrated in FIG. 1, the vehicle system 10 includes an engine control unit (ECU) 90 for controlling the motor(s) 20, and a transmission control unit (TCU) 94 for controlling the transmission 24. Both of the control units 90 and 94 as well as the traction controller 32, driver interface 36, instrument cluster 40 and sensors 80 are in communication with CAN 84 and thus each other. Again, in some examples a transmission 24 and therefore the TCU 94 is not included. It will be appreciated that while individual control units are discussed herein and shown in various Figures, the individual control units may also be optionally implemented in the form of one control unit, such as a powertrain or vehicle control unit, represented by broken line 104 in FIG. 1. Thus, it will be appreciated that while the discussion will continue with reference to the individual controllers discussed above, the discussion is equally applicable to the components of vehicle system 10 being controlled by one controller.

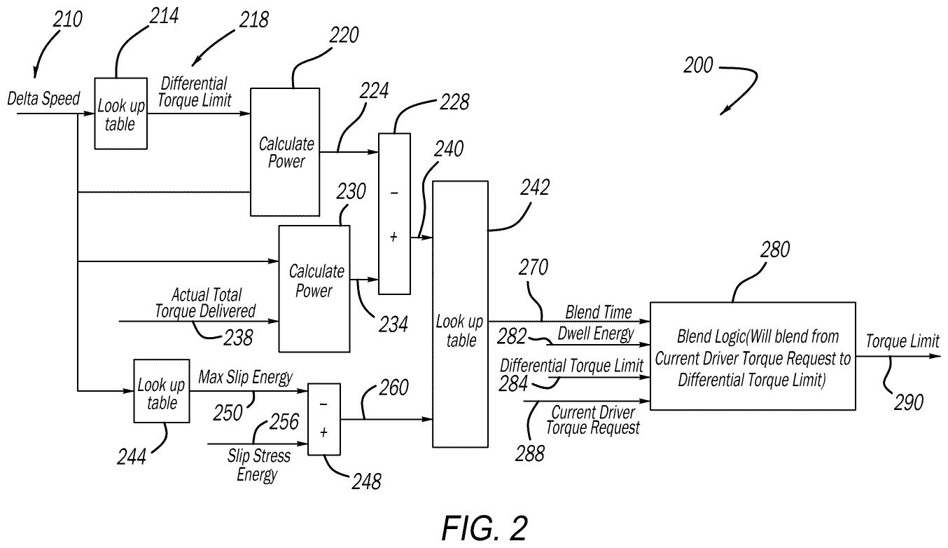

Referring now to FIG. 2, and with reference back to FIG. 1, an exemplary flow diagram illustrating a method for implementing a control strategy for limiting torque delivery from an electric motor to a differential based on wheel slip is shown and identified at reference numeral 200. Various definitions related to inputs and variables used to limit driver torque request will be described. A “slip stress energy” refers to a variable that indicates the magnitude of stress applied on a differential assembly (e.g., at least one of differential assemblies 63, 65) due to wheel speed difference and thermal energy. A “maximum slip stress energy” refers to a maximum energy that are allowed to be applied on the differential assembly without the components being damaged defined by the characteristic of the mechanical components. A “dwell energy” refers to an amount of energy allowed in the system 10 with no intervention. The method 200 will finish blending to the limit once the maximum slip stress energy is reached.

Control determines a delta speed or slip speed 210 based on a difference between wheel speeds of a driven axle. For example, a delta speed 210 can be a difference between the wheel speeds of front wheels 58A and 58B (sensed by the wheel speed sensors 62A, 62B) in a front wheel drive configured vehicle, and/or a difference between the wheel speeds of rear wheels 58C and 58D (sensed by the wheel speed sensors 62C, 62D) in a rear wheel drive (or all-wheel drive) vehicle.

A first look up table 214 can receive the delta speed 210 and output a differential torque limit 218. A first power calculation module 220 can output a first power output 224 into a summation module 228 based on the first power output 224 and the delta speed 210. A second power calculation module 230 can output a second power output, or slip stress power 234 to the summation module 228 based on the delta speed 210 and an actual total (propulsion) torque delivered 238. The summation module 228 outputs a total power output 240 to a third lookup table 242.

A third lookup table 244 outputs a maximum slip energy 250 based on the delta speed 210. A second summation module 248 outputs an energy output 260 to the second lookup table 242 based on the maximum slip energy 250 and a slip stress energy 256. The slip stress energy 256 is calculated based on the integral of slip stress power 234. In examples, the temperature of the transmission is considered (sensors 80) since the time duration of protection to come into effect is inversely proportional to temperature. For example, time duration is shorter as the temperature of the transmission is higher. The second lookup table 242 outputs a blend time 270 based on the total power output 240 and the energy output 260. The blend time is the time duration of applying torque limit to the driver torque request. The torque limit cannot be applied instantly due to the requirement of drivability. Moreover, if the slip stress energy 250 is higher, the risk of differential gear damage is higher, thus the shorter the time of blending. A blend logic module 280 outputs a torque limit 290 based on the blend time 270, a dwell energy 282, a differential torque limit 284 and a driver torque request 288.

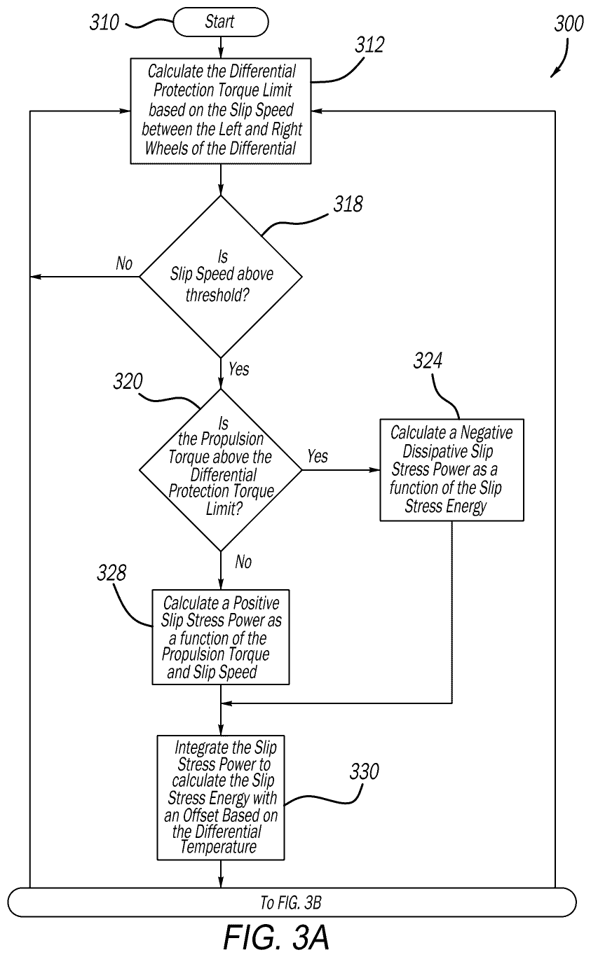

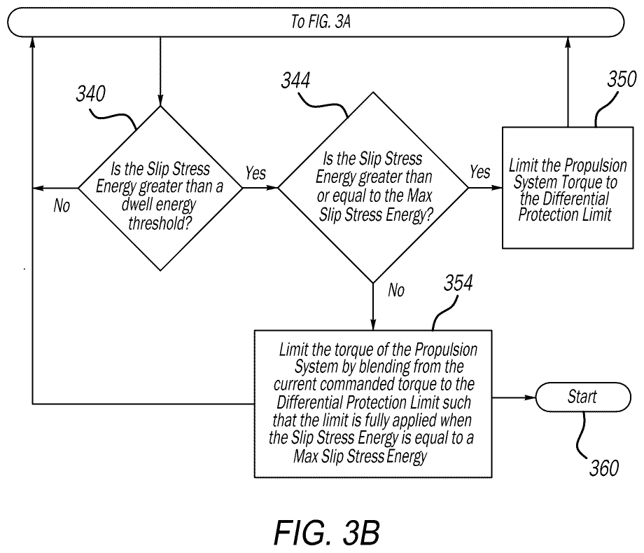

With additional reference now to FIGS. 3A and 3B, a method 300 implemented by the controller 82 of the vehicle system 10 according to various implementations of the present disclosure will be described. The method starts at 310. At 312 control calculates the differential protection torque limit (e.g., 218, FIG. 2) based on the slip speed between the left and right wheels of the differential. (front drive wheels 58A, 58B of front differential 63, and/or rear drive wheels 58C, 58D of rear differential 65). At 318 control determines whether the slip speed 210 is above a threshold. If not, control loops to 312. If the slip speed 210 is above a threshold, at 320 control determines whether the propulsion torque (total torque delivered 238) is above the differential protection torque limit. If control determines that the propulsion torque is above the differential protection torque limit, control calculates a negative dissipative slip stress power as a function of slip stress energy at 324. If control determines that the propulsion torque is not above the differential protection torque limit, control calculates a positive slip stress power 234 as a function of the propulsion torque 238 and slip speed 210 at 328. At 330 control integrates the slip stress power 234 to calculate the slip stress energy 256 with an offset based on differential temperature.

At 340, control determines whether the slip stress energy 256 is greater than a dwell energy threshold. If not, control loops to 312. If the slip stress energy 256 is greater than a dwell energy threshold, control determines whether the slip stress energy 256 is greater than or equal to the maximum slip stress energy 250 at 344. If not, control proceeds to 354. If the slip stress energy 256 is greater than or equal to the maximum stress energy 250, control limits the propulsion system torque to the differential protection limit 290 at 350. At 354, control limits the torque of the propulsion system by blending from the current commanded toque to the differential protection limit such that the limit is fully applied when the slip stress energy 256 is equal to the maximum slip stress energy 250. Control ends at 360.

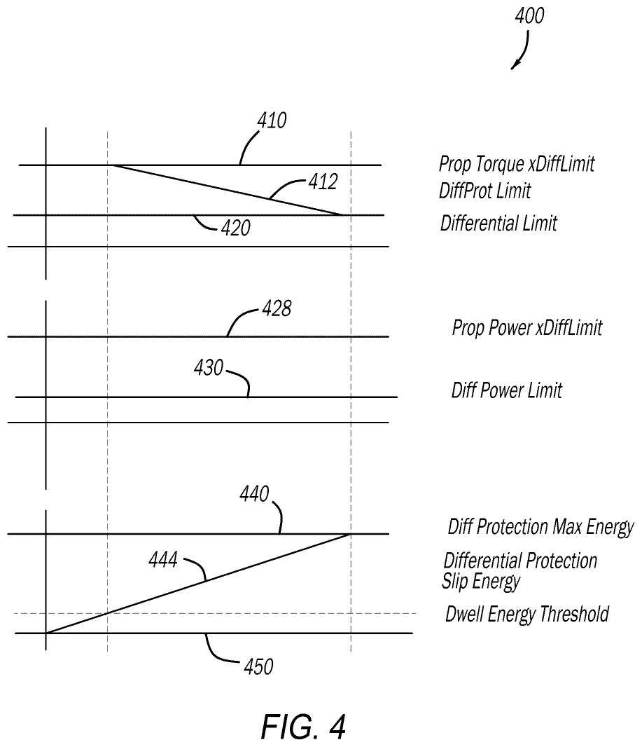

FIG. 4 illustrates various plots 400 showing a slip energy based activation of limits. 410 is a prop torque x differential limit; 420 is a differential protection limit 420; 412 is a differential limit. 428 is a prop power x differential limit; 430 is a differential power limit. 440 is a differential protection maximum energy; 444 is a differential protection slip energy; 450 is a dwell energy threshold.

It will be appreciated that the term “controller” as used herein refers to any suitable control device or set of multiple control devices that is/are configured to perform at least a portion of the techniques of the present disclosure. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present disclosure. The one or more processors could be either a single processor or two or more processors operating in a parallel or distributed architecture.

It should be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A vehicle system for an electrified vehicle that limits torque delivery to drive wheels of the electrified vehicle, the vehicle system comprising:
an electric motor that provides propulsion torque to a driveline that drives the drive wheels for propelling the vehicle, the drive wheels including left and right drive wheels receiving the propulsion torque through a differential assembly;
a first wheel speed sensor that communicates a first wheel speed signal of the left drive wheel and a second wheel speed sensor that communicates a second wheel speed signal of the right drive wheel; and
a controller that:
receives the first and second wheel speed signals;
determines, based on a difference between the first and second wheel speed signals, a differential protection torque limit;
determines whether the propulsion torque exceeds a differential protection torque limit;
determines a slip stress power;
determines a slip stress energy based on the slip stress power;
determines whether the slip stress energy is greater than a dwell energy threshold;
determines whether the slip stress energy is greater than or equal to a maximum slip stress energy; and
commands, at the electric motor, the propulsion torque to the differential protection limit based on the slip stress energy being greater than or equal to the maximum slip stress energy.

2. The vehicle system of claim 1, wherein the controller is further configured to:
command, at the electric motor, a blending in from a driver commanded propulsion torque to the differential protection limit.

3. The vehicle system of claim 1, wherein the controller is further configured to:
command, at the electric motor, the blending until the slip stress energy is equal to the maximum slip stress energy.

4. The vehicle system of claim 1, wherein the controller is further configured to:
determine the slip stress power including calculating a positive slip stress power as a function of the propulsion torque and the slip speed.

5. The vehicle system of claim 1, wherein the controller is further configured to:
determine the slip stress power including calculating a negative dissipative slip stress power as a function of the slip stress energy.

6. The vehicle system of claim 1, wherein the left and right drive wheels comprise left and right front drive wheels.

7. The vehicle system of claim 1, wherein the left and right drive wheels comprise left and right rear drive wheels.

8. The vehicle system of claim 1, wherein the left and right drive wheels comprise:
left and right front drive wheels; and
left and right rear drive wheels.

9. A method for limiting torque delivery to drive wheels of an electrified vehicle, the electrified vehicle having: an electric motor that provides propulsion torque to a driveline that drives the drive wheels for propelling the vehicle, the drive wheels including left and right drive wheels receiving the propulsion torque through a differential assembly; a first wheel speed sensor that communicates a first wheel speed signal of the left drive wheel and a second wheel speed sensor that communicates a second wheel speed signal of the right drive wheel; and a controller, the method comprising:
receiving, at the controller, the first and second wheel speed signals;
determining, at the controller, based on a difference between the first and second wheel speed signals, a differential protection torque limit;
determining, at the controller, whether the propulsion torque exceeds a differential protection torque limit;
determining, at the controller, a slip stress power;
determining, at the controller, a slip stress energy based on the slip stress power;
determining, at the controller, whether the slip stress energy is greater than a dwell energy threshold;
determining, at the controller, whether the slip stress energy is greater than or equal to a maximum slip stress energy; and
commanding, at the electric motor, the propulsion torque to the differential protection limit based on the slip stress energy being greater than or equal to the maximum slip stress energy.

10. The method of claim 9, further comprising:
commanding, at the electric motor, a blending in from a driver commanded propulsion torque to the differential protection limit.

11. The method of claim 9, further comprising:
commanding, at the electric motor, the blending until the slip stress energy is equal to the maximum slip stress energy.

12. The method of claim 9, further comprising:
determining, at the controller, the slip stress power including calculating a positive slip stress power as a function of the propulsion torque and the slip speed.

13. The method of claim 9, further comprising:
determining, at the controller, the slip stress power including calculating a negative dissipative slip stress power as a function of the slip stress energy.

14. The method of claim 9, wherein the left and right drive wheels comprise left and right front drive wheels.

15. The method of claim 9, wherein the left and right drive wheels comprise left and right rear drive wheels.

16. The method of claim 1, wherein the left and right drive wheels comprise:
left and right front drive wheels; and
left and right rear drive wheels.
